(19) United States
(12) Patent Application Publication
(10) Pub. No.: US 2011/0102421 A1
(43) Pub. Date: May 5, 2011

(54) INFORMATION PROCESSING DEVICE, IMAGE DISPLAY METHOD, AND COMPUTER PROGRAM

(75) Inventors: Takanori MINAMINO, Kanagawa (JP); Mitsuo OKUMURA, Tokyo (JP)

(73) Assignee: SONY CORPORATION, Tokyo (JP)

(21) Appl. No.: 12/859,562

(22) Filed: Aug. 19, 2010

(30) Foreign Application Priority Data
Oct. 30, 2009 (JP) 2009-250803

(51) Int. Cl. G06T 15/00

(52) U.S. Cl. 345/419

(57) ABSTRACT

An information processing device includes an image generator that generates a first image representing a content and one or more second images from the content including the first image, and a display controller that displays the one or more first images on a first plane in a depth direction as seen from an image display screen, aligns one or more second images on an axis three-dimensionally perpendicular to the first plane on which the first images are displayed, and displays the images as a first screen.

### BACKGROUND OF THE INVENTION

1. Field of the Invention

The present invention relates to an information processing device, an image display method, and a computer program.

2. Description of the Related Art

Software operating on a video camera or a personal computer includes a function to display a list of captured still images or moving images in the form of thumbnail images (for example, refer to Japanese Unexamined Patent Application Publication No. 2009-164828).

In such software operating on a video camera or a personal computer, there is a method for searching for a desired moving image from a plurality of moving images by displaying a list of representative images of a plurality of moving images (for example, images of the first frames of the moving images) and an image group in which still images of an moving image of a plurality of moving images are arranged chronologically at a predetermined interval (hereinafter, such an image group is referred to as “film roll images”) in the same screen. When an image is selected from the film roll images, a moving image can be reproduced from a frame corresponding to the image, so that, by reproducing the moving image, it is easy to check the content of the moving image. In the related art, the list of representative images and the film roll images are arranged and displayed on the same two-dimensional plane.

### SUMMARY OF THE INVENTION

However, in the display method of the related art, the list of representative images and the film roll images are arranged and displayed on the same two-dimensional plane, and thus there is a problem that it is difficult to understand the correspondence relationship that the film roll images are a group image formed by selecting one of the representative images and chronologically arranging still images included in a moving image corresponding to the representative image.

Although there is a method for displaying the film roll images by switching screen between an index screen on which only the list of representative images is displayed and a film roll screen on which both the list of representative images and the film roll images are displayed, if the index screen is instantly switched to the film roll screen, there is a problem that it is difficult to understand the correspondence relationship between the index screen and the film roll screen.

In light of the foregoing, it is desirable to provide a novel and improved information processing device, image display method, and computer program which enable easy understanding of the correspondence relationship between the index screen and the film roll screen.

According to an embodiment of the present invention, there is provided an information processing device including an image generator that generates a first image and one or more second images from a content including the first image, and a display controller that displays the one or more first images on a first plane in a depth direction as seen from an image display screen, aligns one or more second images on an axis three-dimensionally perpendicular to the first plane on which the first images are displayed, and displays the images as a first screen.

The display controller may switch the screen from a second screen in which the first images are arranged on a second plane different from the first plane displayed in the first screen in the image display screen to the first screen by animation.

When the display controller switches the screen from the second screen to the first screen, the display controller may switch a display plane of the first images from the second plane to the first plane by animation, and when the switching of the first images is completed, the display controller may align and display the second images on an axis three-dimensionally perpendicular to the first plane.

The display controller may display the second images as if the second images popped up from the first plane by animation.

When the display controller switches the screen from the second screen to the first screen, the display controller may switch the image display screen of the first images from the second plane to the first plane by animation after framing out a part of the first images from the image display screen.

The display controller may switch the screen from the first screen to a second screen in which the first images are arranged on a second plane different from the first plane displayed in the first screen in the image display screen by animation.

When the display controller switches the screen from the first screen to the second screen, the display controller may switch the display plane of the first images from the first plane to the second plane by animation after erasing the display of the second images.

The display controller may display the second images as if the second images were moving to the first plane by animation.

When the display controller switches the screen from the first screen to the second screen, the display controller may switch the display plane of the first images from the first plane to the second plane by animation after framing out a part of the first images from the image display screen.

The second images show the content including the first image at a predetermined chronological interval, and chronologically newer second image may be located nearer to the first plane on the axis three-dimensionally perpendicular to the first plane.

The display controller may display the second images so that the second image tilts steeper as the distance between the second image and the first plane increases.

The display controller may display the second images so that all the second images are tilted at the same angle on the axis three-dimensionally perpendicular to the first plane.

The display controller may scroll the second images on the axis three-dimensionally perpendicular to the first plane in accordance with a user operation.

The display controller may display shades of the second images in accordance with the display of the second images.

The display controller may display the second images by adding an effect for floating the second images from an area around the second images.

The first image may be an image of a first frame of the content.

The display controller displays a calendar on the first plane, and the first image may be an image captured for the first time on a date among images captured on the date.

The display controller may semi-transparently display the first images displayed on the first plane.

According to another embodiment of the present invention, there is provided an image display method including the steps of: generating a first image representing a content and one or more second images from the content including the first image; and displaying the one or more first images on a first plane in a depth direction as seen from an image display screen, aligning one or more second images on an axis three-dimensionally perpendicular to the first plane on which the first images are displayed, and displaying the images as a first screen.

According to another embodiment of the present invention, there is provided an image display method for causing a computer to execute the steps of: generating a first image representing a content and one or more second images from the content including the first image; and displaying the one or more first images on a first plane in a depth direction as seen from an image display screen, aligning one or more second images on an axis three-dimensionally perpendicular to the first plane on which the first images are displayed, and displaying the images as a first screen.

As described above, according to an embodiment of the present invention, it is possible to provide a novel and improved information processing device, image display method, and computer program which enable easy understanding of the correspondence relationship between the index screen and the film roll screen by displaying the film roll images on an axis perpendicular to the list of representative images.

### BRIEF DESCRIPTION OF THE DRAWINGS

FIG. 1 is an illustration showing a configuration of a digital video camera according to an embodiment of the present invention;

FIG. 2 is an illustration showing a display example of an index screen;

FIG. 3 is an illustration showing a display example of a film roll screen;

FIG. 4A is an illustration showing a switching operation between the index screen and the film roll screen;

FIG. 4B is an illustration showing the switching operation between the index screen and the film roll screen;

FIG. 4C is an illustration showing the switching operation between the index screen and the film roll screen;

FIG. 4D is an illustration showing the switching operation between the index screen and the film roll screen;

FIG. 5A is an illustration showing a drawing method for three-dimensionally drawing a film roll image on a two-dimensional plane;

FIG. 5B is an illustration showing a drawing method for three-dimensionally drawing a film roll image on a two-dimensional plane;

FIG. 6 is an illustration showing a drawing method for three-dimensionally drawing the film roll screen on a two-dimensional plane;

FIG. 7 is an illustration showing a drawing method for three-dimensionally drawing the film roll screen on an LCD panel;

FIG. 8A is an illustration showing a modified example of a switching method between the index screen and the film roll screen;

FIG. 8B is an illustration showing the modified example of the switching method between the index screen and the film roll screen;

FIG. 8C is an illustration showing the modified example of the switching method between the index screen and the film roll screen;

FIG. 8D is an illustration showing the modified example of the switching method between the index screen and the film roll screen;

FIG. 9A is an illustration showing another example of the index screen;

FIG. 9B is an illustration showing a display example of the film roll screen formed by selecting a date on a calendar screen shown in FIG. 9A;

FIG. 10A is an illustration showing another display example of the index screen;

FIG. 10B is an illustration showing another example of the switching operation between the index screen and the film roll screen; and

FIG. 10C is an illustration showing another display example of the film roll screen.

### DESCRIPTION OF THE PREFERRED EMBODIMENTS

Hereinafter, a preferred embodiment of the present invention will be described in detail with reference to the accompanying drawings. In this specification and the drawings, constituent elements having substantially the same function and configuration are given the same reference numerals, and redundant description will be omitted.

The description will be made in the following order.

<1. Embodiment of the present invention>

[1-1. Configuration of digital video camera]

[1-2. Display example of index screen and film roll screen]

[1-3. Example of switching between index screen and film roll screen]

[1-4. Method for drawing film roll image]

[1-5. Method for drawing film roll screen]

[1-6. Modified example of switching method]

[1-7. Modified example of representative image]

[1-8. Modified example of index screen and film roll screen]

<2. Overview>

### 1. EMBODIMENT OF THE PRESENT INVENTION

### 1-1. Configuration of Digital Video Camera

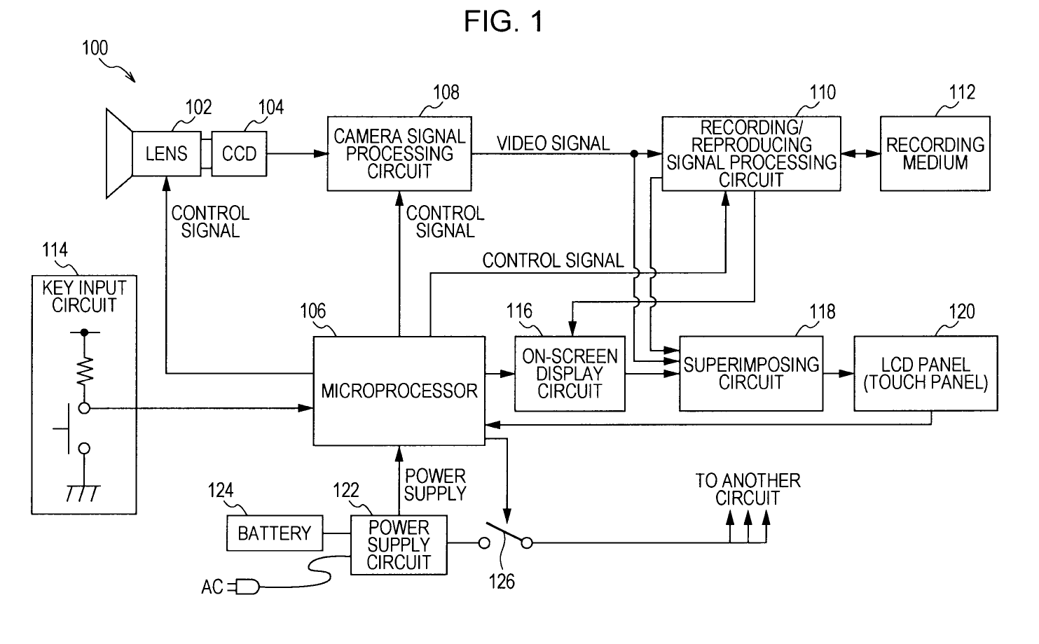

First, a configuration of a digital video camera according to an embodiment of the present invention will be described. The digital video camera is an example of an information processing device according to the embodiment of the present invention. FIG. 1 is an illustration showing a configuration of a digital video camera 100 according to the embodiment of the present invention. Hereinafter, the configuration of the digital video camera 100 according to the embodiment of the present invention will be described with reference to FIG. 1.

As shown in FIG. 1, the digital video camera 100 includes a lens 102, a CCD image sensor 104, a microprocessor 106, a camera signal processing circuit 108, a recording/reproducing signal processing circuit 110, a recording medium 112, a key input circuit 114, an on-screen display circuit 116, a superimposing circuit 118, an LCD panel 120, a power supply circuit 122, a battery 124, and a power supply controller 126.

The lens 102 collects light from an object. The lens 102 includes a focus lens for focusing the object and a zoom lens for changing an imaging magnification. The light collected by the lens 102 is irradiated to the CCD image sensor 104.

The CCD image sensor 104 photoelectrically converts the light collected by the lens 102 and generates an electrical signal. The electrical signal generated by the CCD image sensor 104 is sent to the camera signal processing circuit 108.

The microprocessor 106 controls each component of the digital video camera 100. For example, the microprocessor 106 sends a control signal to each component of the digital video camera 100 in accordance with user operation from the key input circuit 114 or the touch panel type LCD panel 120. For example, when a user tries to change the magnification of the object by operating the key input circuit 114, the microprocessor 106 sends a control signal for driving the zoom lens to the lens 102 in accordance with a signal from the key input circuit 114.

The camera signal processing circuit 108 generates moving image data by performing predetermined signal processing on the electrical signal generated by the CCD image sensor on the basis of the control signal from the microprocessor 106. The signal processing performed by the camera signal processing circuit 108 includes, for example, A/D conversion processing, white balance processing, gamma correction processing, color separation processing, and so on. The moving image data generated by the camera signal processing circuit 108 is sent to the recording/reproducing signal processing circuit 110.

The recording/reproducing signal processing circuit 110 stores the moving image data generated by the camera signal processing circuit 108 into the recording medium 112 and reads the moving image data stored in the recording medium 112 to reproduce the moving image. The recording medium 112 stores the moving image data generated by the camera signal processing circuit 108, and the recording/reproducing signal processing circuit 110 reads/writes the moving image data from/to the recording medium 112. The recording medium 112 may be, for example, a hard disk, a recording medium that contains a flash memory, or an optical disk that records data by using a semiconductor laser.

The recording/reproducing signal processing circuit 110 has a function to generate representative images from the moving image data stored in the recording medium 112 and display a list of a plurality of representative images on the LCD panel 120 as an index screen through the on-screen display circuit 116 described below. Therefore, the recording/reproducing signal processing circuit 110 functions as an example of an image generator according to the embodiment of the present invention. The recording/reproducing signal processing circuit 110 has a function to generate film roll images by extracting frames of the moving image data stored in the recording medium 112 at a predetermined interval and display the generated film roll images on the LCD panel 120 through the on-screen display circuit 116. For example, to generate a film roll image at a 10-second interval from a moving image of 30 frames per second, the recording/reproducing signal processing circuit 110 can generate film roll images by extracting frames at a 300-frame interval. The frame interval of the film roll images can be arbitrarily changed by a user operation of the key input circuit 114.

The key input circuit 114 receives various user operations for the digital video camera 100. The various user operations include, for example, starting and stopping recording of moving image using the digital video camera 100, reproducing the moving image data stored in the recording medium 112 and stopping the reproduction, and changing various settings of the digital video camera 100. The signal from the key input circuit 114 is sent to the microprocessor 106 after A/D conversion, and the control signal is sent from the microprocessor 106 to each component of the digital video camera 100 in accordance with a user operation.

The on-screen display circuit 116 generates a video signal to display a requested GUI (Graphical User Interface) screen on the basis of a screen display request signal from the microprocessor 106, and in this embodiment, in particular, the on-screen display circuit 116 performs image processing on the representative images and the film roll images generated by the recording/reproducing signal processing circuit 110. Therefore, the on-screen display circuit 116 functions as an example of a display controller according to the embodiment of the present invention. In this embodiment, the on-screen display circuit 116 performs three-dimensional drawing on the index screen including representative images and the film roll screen including a plurality of film roll images. Owing to the three-dimensional drawing by the on-screen display circuit 116, it is possible to display a screen on the LCD panel 120 so that the correspondence relationship between the index screen and the film roll screen can be easily understood. The three-dimensional drawing on the index screen and the film roll screen by the on-screen display circuit 116 will be described later.

The superimposing circuit 118 superimposes data on which image processing is performed by the on-screen display circuit 116 on the moving image data generated by the camera signal processing circuit 108 and the moving image data read from the recording medium 112 by the recording/reproducing signal processing circuit 110. The moving image data on which data is superimposed by the superimposing circuit 118 is sent to the LCD panel 120.

The LCD panel 120 displays an image on the basis of the moving image data or the like sent from the superimposing circuit 118. In this embodiment, the LCD panel 120 includes a touch panel function, and a user can perform various operations by touching the LCD panel 120. A signal that is caused by a user touching the LCD panel 120 and outputted from the LCD panel 120 is sent to the microprocessor 106. Although in this embodiment, an LCD panel is used to display an image, it is needless to say that the present invention is not limited to this, and for example, an organic EL panel or other panels may be used.

The power supply circuit 122 supplies power to the microprocessor 106 and the battery 124. The power supplied from the power supply circuit 122 to the microprocessor is supplied from an AC power supply connected to the digital video camera 100 or from the battery 124. The battery 124 is charged when the digital video camera 100 is connected to AC power supply, and the battery 124 supplies power to the power supply circuit 122 when the digital video camera 100 is not connected to AC power supply. The power supply controller 126 controls power supplied to circuits not shown in FIG. 1 in the digital video camera 100 by the control signal from the microprocessor 106.

The configuration of the digital video camera 100 according to the embodiment of the present invention has been described with reference to FIG. 1. Next, a screen displayed on the LCD panel 120 of the digital video camera 100 according to the embodiment of the present invention will be described. In the description below, the screen displayed on the LCD panel 120 is generated by the on-screen display circuit 116 unless otherwise stated.

### 1-2. Display Example of Index Screen and Film Roll Screen

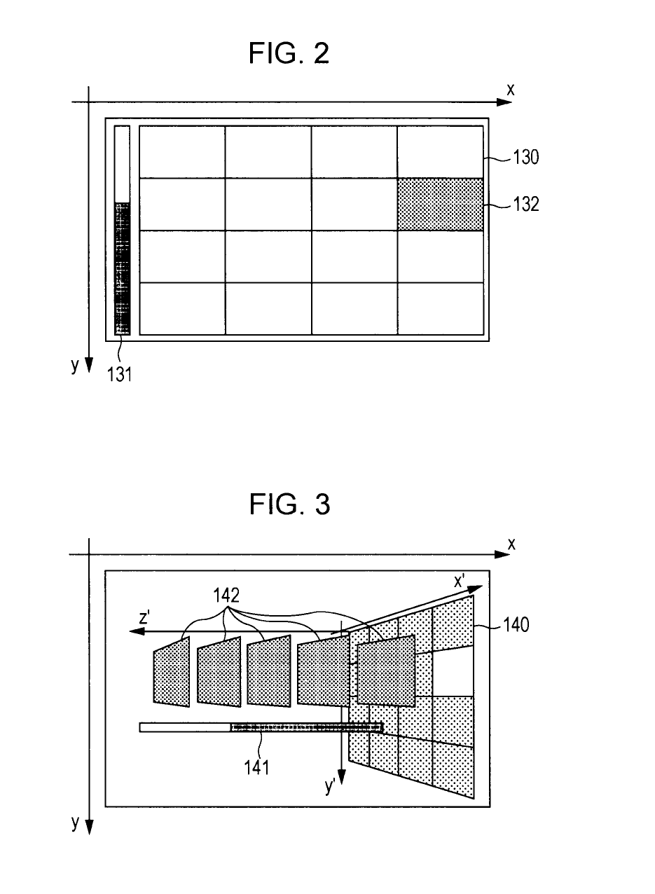

Among screens displayed on the LCD panel 120, FIG. 2 is an illustration showing a display example of the index screen on which a list of a plurality of representative images is displayed. The index screen shown in FIG. 2 is displayed on the LCD panel 120 on the basis of a predetermined user operation. In FIG. 2, the x axis and the y axis of the LCD panel 120 are also shown. FIG. 2 shows the index screen on which 16 representative images 130 which are a first frame image of each moving image data stored in the recording medium 112 are arranged in 4 horizontal rows and 4 vertical columns. As described above, the LCD panel 120 has a touch panel function, and a user can select a representative image by directly touching the screen. When the screen is too small to display all the representative images, by displaying a scroll bar 131 on the LCD panel 120, it is possible to estimate how many representative images 130 are included in the index screen.

When a user selects a representative image (for example, representative image 132) from the plurality of representative images 130 displayed on the index screen, film roll images are generated from moving image data including the representative image by the recording/reproducing signal processing circuit 110, and the index screen switches to the film roll screen. When the microprocessor 106 detects that the representative image is selected by the user, the microprocessor 106 sends a control signal to switch the index screen to the film roll screen to the on-screen display circuit 116. When selecting a representative image, the user may select the representative image by directly touching the LCD panel 120, or by operating keys of the digital video camera 100.

When the microprocessor 106 detects that a representative image in the index screen is selected, the on-screen display circuit 116 switches the screen displayed on the LCD panel 120 from the index screen to the film roll screen. Among screens displayed on the LCD panel 120, FIG. 3 is an illustration showing a display example of the film roll screen on which a plurality of film roll images are displayed chronologically. The film roll screen is displayed on the LCD panel 120 by using an x′ axis and a y′ axis, which are different from the x axis and the y axis of the LCD panel 120, and z′ axis. In the film roll screen, an index screen including a plurality of representative images 140 is displayed on an x′y′ plane, and film roll images 142 are displayed chronologically in a z′ axis direction. The film roll images 142 displayed in the z′ axis direction are displayed in chronological order from the left of FIG. 3.

A user can select any one of the plurality of film roll images 142 displayed on the screen. The film roll image can be selected by touching the LCD panel using a finger or the like. When the microprocessor 106 detects that an image among the plurality of film roll images 142 is selected by a user, the microprocessor 106 instructs to reproduce moving image data from a frame corresponding to the selected image.

A scroll bar 141 is displayed below the film roll images 142, so that it is possible to estimate how many film roll images 142 are present in one moving image data. A user can scroll the film roll images 142 to left and right by touching the area where the film roll images 142 are displayed by using a finger or the like and moving the film roll images 142 to left and right in the z′ axis direction. As shown in FIG. 3, as the film roll image 142 is located nearer to the left edge of the screen, in other words, as the film roll image 142 is located farther from the plane on which the plurality of representative images 140 are displayed, the film roll image 142 may be displayed so that the film roll image 142 is tilted steeper. The on-screen display circuit 116 may display the first film roll image in a portion of the film roll screen shown in FIG. 3 (for example, in a lower left portion of the screen). When the on-screen display circuit 116 displays the first film roll image on the film roll screen, a user can easily know the first image of the film roll images displayed on the LCD panel 120.

In the film roll screen shown in FIG. 3, the on-screen display circuit 116 may semi-transparently draw the plurality of representative images 140 displayed on the x′y′ plane. By semi-transparently displaying the plurality of representative images 140, there is an effect that the film roll images 142 looks floating. Also, in the film roll screen shown in FIG. 3, the on-screen display circuit 116 may draw shaded film roll images 142 or framed film roll images 142 in accordance with the display of the film roll images 142 displayed on the z′ axis. For example, in the film roll screen shown in FIG. 3, the on-screen display circuit 116 may draw the shades of the film roll images 142 below the film roll images 142, assuming that light is irradiated from above the screen. By drawing shaded film roll images 142 or by drawing framed film roll images 142 in accordance with the display of the film roll images 142, also there is an effect that the film roll images 142 looks floating.

### 1-3. Example of Switching Between Index Screen and Film Roll Screen

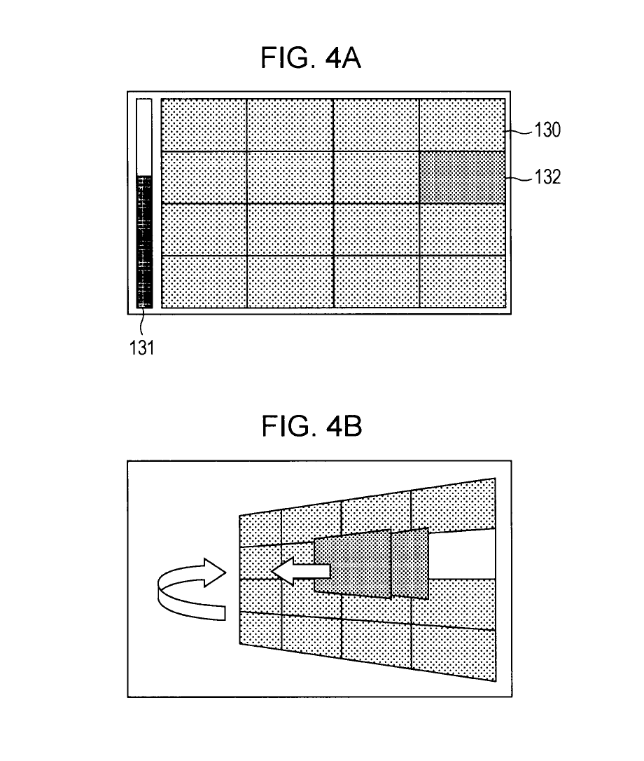

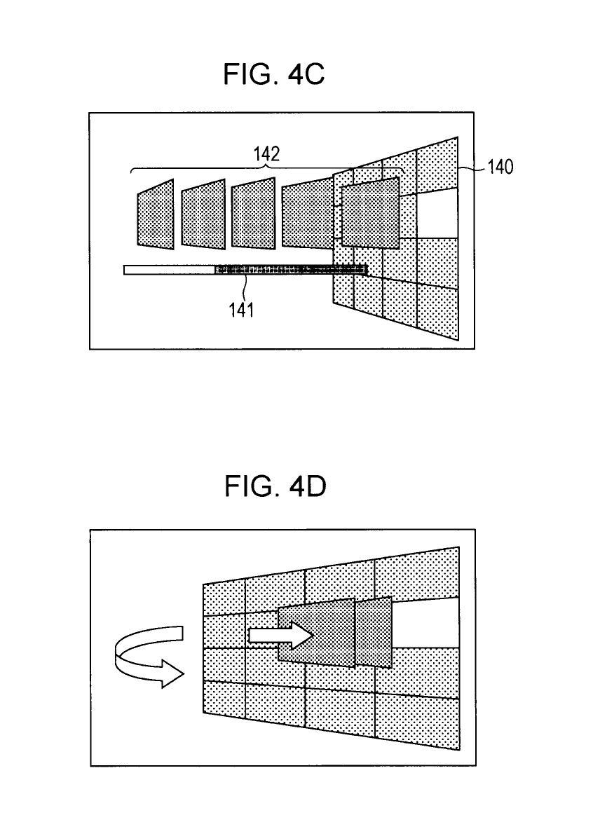

Here, a switching operation from the index screen shown in FIG. 2 to the film roll screen shown in FIG. 3 using animation will be described with reference to the drawings. FIGS. 4A to 4D are illustrations showing the switching operation from the index screen to the film roll screen or vice versa.

First, an index screen on which a plurality of representative images are displayed in matrix form as shown in FIG. 4A is displayed on the LCD panel 120. Although said repeatedly, in the index screen shown in FIG. 4A, a plurality of representative images 130 and the scroll bar 131 are displayed. When one representative image (for example, representative image 132) is selected from the plurality of representative images 130 in the index screen shown in FIG. 4A, the on-screen display circuit 116 starts a switching operation from the index screen to the film roll screen.

When the representative image 132 in FIG. 4A is selected, as shown in FIG. 4B, the on-screen display circuit 116 performs animation drawing processing so that it looks like that the plurality of representative images 130 rotate in the depth direction of the screen. In this case, the position of the selected representative image 132 is displayed as a blank. Then, film roll images corresponding to the selected representative image 132 are generated by the recording/reproducing signal processing circuit 110. The generated film roll images are drawn by the on-screen display circuit 116 so that the film roll images pop up from the plane on which the plurality of representative images 130 are displayed and are arranged sequentially in the z′ axis direction in FIG. 3.

The above-mentioned rotational drawing of the representative images 130 and the sequential arrangement drawing of the film roll images are performed in parallel by the on-screen display circuit 116, and finally the screen switches from the index screen shown in FIG. 4A to the film roll screen shown in FIG. 4C. Although said repeatedly, in the film roll screen shown in FIG. 4C, a plurality of representative images 140, the scroll bar 141, and the film roll images 142 are displayed.

In this way, the film roll images 142 generated from moving image data corresponding to the representative image selected from the plurality of representative images 140 are displayed on the axis perpendicular to the plane on which the plurality of representative images 140 are displayed, so that it is easy to understand the correspondence relationship between the index screen and the film roll screen. The screen is switched from the index screen to the film roll screen by animation, so that the operation of the index screen and the operation of the film roll screen are separated from each other, and it is easy to understand the correspondence relationship between the representative image selected by a user and the film roll images.

In the film roll screen as shown in FIG. 4C, when a user has checked the film roll screen, the user can switch back the film roll screen to the index screen by a user operation. When a predetermined user operation (for example, touching an area where no film roll image 142 is displayed in the film roll screen by using a finger or the like) is performed, by using the user operation as a trigger, the on-screen display circuit 116 performs the switching operation from the film roll screen to the index screen.

When the user operation for switching the film roll screen to the index screen is performed, as shown in FIG. 4D, the on-screen display circuit 116 performs drawing processing so that it looks like that the plurality of representative images 140 rotate frontward of the screen. The on-screen display circuit 116 performs drawing processing in which the displayed film roll images are sequentially moved back toward the right of the z′ axis and folded up. When the film roll images are completely folded up and the plurality of representative images are rotated to the xy plane, the switching operation to the index screen as shown in FIG. 4A is completed. The folded-up film roll images are inserted in the blank position in the index screen.

In this way, when switching from the film roll screen to the index screen, the drawing processing in which the film roll images are moved back in the chronological direction and folded up is performed, and the folded-up film roll images are inserted in the blank position in the index screen, so that it is easy to know the position where the moving image data displayed as the film roll images was displayed in the index screen.

The time used to switch from the index screen to the film roll screen and the time used to switch from the film roll screen to the index screen may be held in the digital video camera 100 as setting values in advance, or may be set to any time by a user.

### 1-4. Method for Drawing Film Roll Image

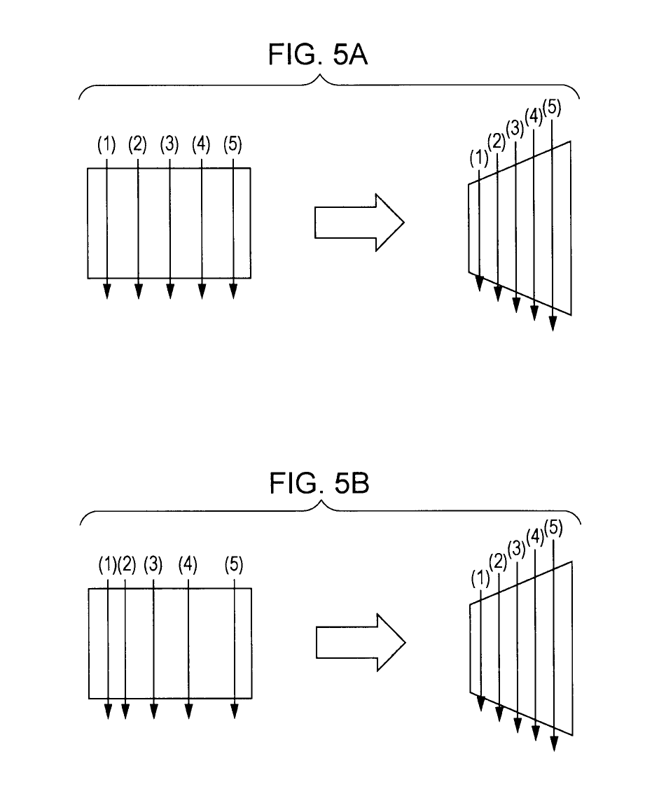

Next, the drawing method of a film roll image will be described using an example. FIGS. 5A and 5B are illustrations showing the drawing method for three-dimensionally drawing a film roll image on the LCD panel 120 (on a two-dimensional plane).

When three-dimensionally drawing a film roll image on the LCD panel 120, first, the on-screen display circuit 116 vertically scans and reads an original image of the film roll image for the number of times corresponding to the number of horizontal pixels of the film roll image having been transformed into a trapezoidal shape. For example, when the number of horizontal pixels of the film roll image having been transformed is 50, the original image is vertically scanned 50 times. The on-screen display circuit 116 enlarges or reduces the read information in the vertical direction, so that a film roll image having a trapezoidal shape is generated. When the on-screen display circuit 116 scans the original image, as shown in FIG. 5A, the on-screen display circuit 116 may scan at the same interval, or as shown in FIG. 5B, the on-screen display circuit 116 may scan at a longer interval as the scanning position approaches the long side of the trapezoidal shape having been transformed.

### 1-5. Method for Drawing Film Roll Screen

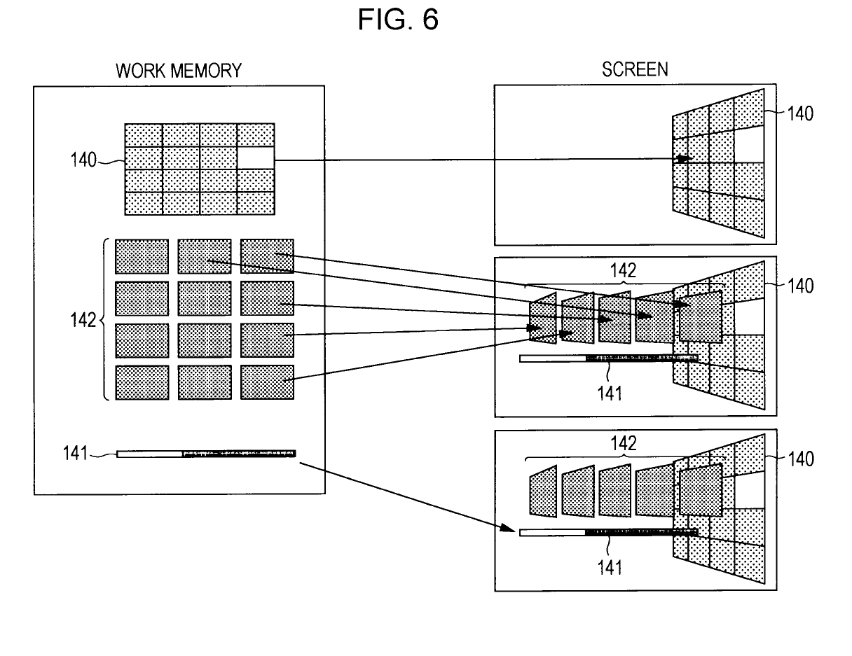

Next, the drawing method of the film roll screen will be described using an example. FIG. 6 is an illustration showing a drawing method for three-dimensionally drawing the film roll screen on a two-dimensional plane. When three-dimensionally drawing the film roll screen, first, the on-screen display circuit 116 temporarily stores a plurality of representative images 140 and the film roll images 142 displayed on the index screen into a work memory. The scroll bar 141 is also stored in the work memory. For example, the work memory may be provided in the on-screen display circuit 116.

The on-screen display circuit 116 draws all of the plurality of representative images 140 stored in the work memory into a trapezoidal shape. When the on-screen display circuit 116 draws the plurality of representative images 140 into a trapezoidal shape, as shown in FIGS. 4A to 4C, the on-screen display circuit 116 sequentially performs drawing processing in which the representative images 140 rotate toward the depth direction of the xy plane.

In parallel with the drawing processing of all of the plurality of representative images 140 on the LCD panel 120, or after the drawing processing of all of the plurality of representative images 140 on the LCD panel 120 is completed, the on-screen display circuit 116 sequentially performs transformation drawing processing of the film roll image 142 on the LCD panel 120 one by one. When the transformation drawing processing of the film roll images 142 on the LCD panel 120 is completed, the on-screen display circuit 116 draws the scroll bar 141 on the LCD panel 120.

In this way, the on-screen display circuit 116 performs the drawing processing, so that the film roll screen can be three-dimensionally drawn on a two-dimensional plane.

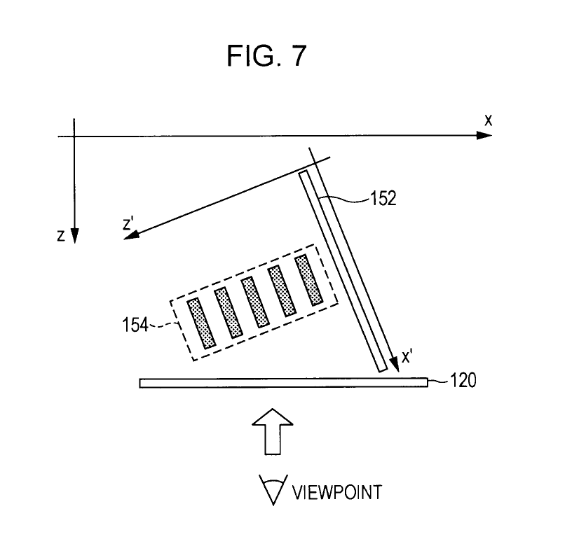

The film roll screen may be drawn on the LCD panel 120 by three-dimensional drawing. FIG. 7 is an illustration showing a drawing method for three-dimensionally drawing the film roll screen on the LCD panel 120. The on-screen display circuit 116 arranges a list of a plurality of representative images 152 on the x′y′ plane rotated by a predetermined angle around the right side of the screen and film roll images 154 in the z′ axis direction with respect to the screen on the xy plane (LCD panel 120). In this situation, the on-screen display circuit 116 perspectively projects the list of representative images 152 and the film roll images 154 on the screen surface. By performing such drawing processing, the list of representative images 152 and the film roll images 154 arranged in a three-dimensional space can be two-dimensionally drawn on the LCD panel 120.

In the above description, the drawing method of the film roll screen has been described using an example. Next, a modified example of the switching method between the index screen and the film roll screen will be described.

### 1-6. Modified Example of Switching Method

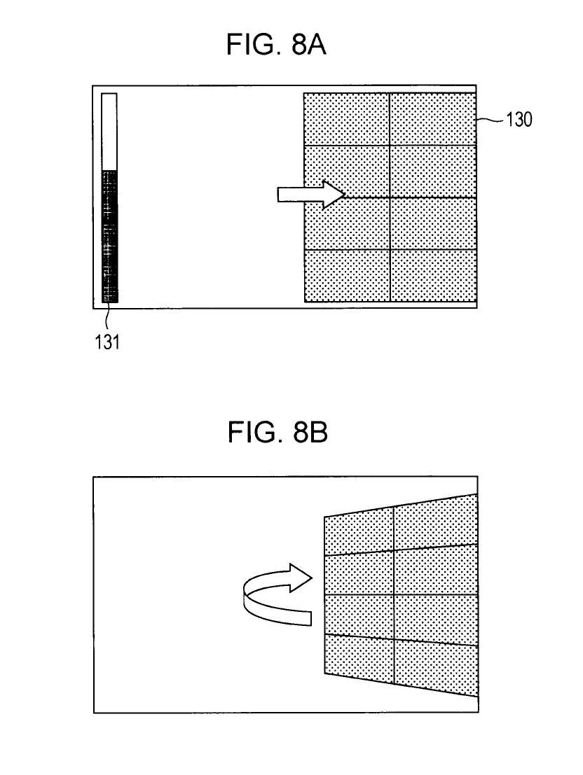

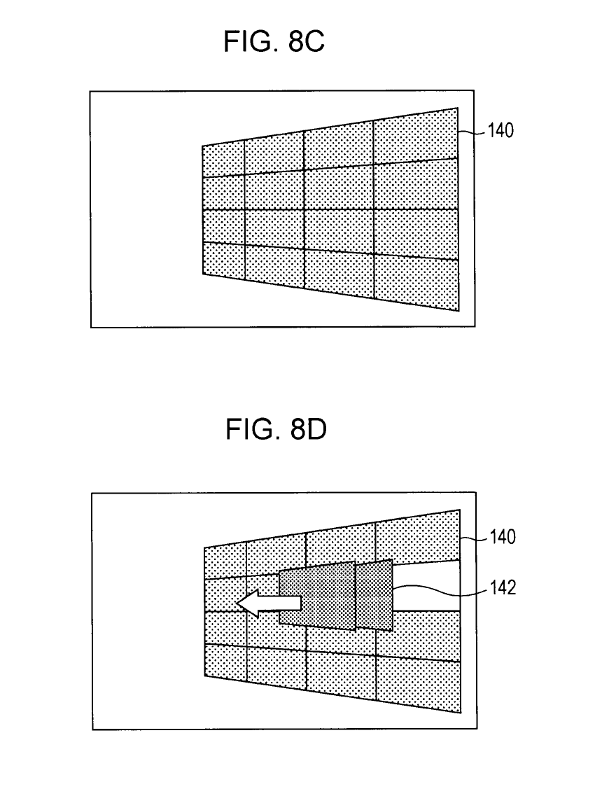

FIGS. 8A to 8D are illustrations showing a modified example of the switching method between the index screen and the film roll screen. First, the index screen on which a plurality of representative images are displayed in matrix form as shown in FIG. 4A is displayed on the LCD panel 120 by the on-screen display circuit 116. On the index screen shown in FIG. 4A, a plurality of representative images 130 and the scroll bar 131 are displayed by the on-screen display circuit 116. In this situation, when one representative image 132 is selected by a user, as shown in FIG. 8A, the on-screen display circuit 116 performs drawing processing in which all of the plurality of representative images 130 shift rightward, two columns are hidden, and the number of the displayed representative images is halved.

When the two columns are hidden and the number of the displayed representative images is halved, as shown in FIG. 8B, the on-screen display circuit 116 performs drawing processing in which the display of the scroll bar 131 is erased and the representative images are rotated in the depth direction of the LCD panel 120. When the rotational drawing is completed, as shown in FIG. 8C, the on-screen display circuit 116 performs drawing processing in which the list of representative images is slid and the hidden representative images are displayed on the LCD panel 120.

As shown in FIG. 8C, when a plurality of representative images 140 have been drawn on the x′y′ plane, as shown in FIG. 8D, the on-screen display circuit 116 performs sequential arrangement drawing of the film roll images.

In this way, a part of the plurality of representative images is erased and the rotational drawing is performed when the index screen is switched to the film roll screen, so that it is possible to lighten the load of the rotational processing compared with the case shown in FIGS. 4A to 4D. It is needless to say that the number of the representative images to be erased is not limited to the example shown in FIG. 8B.

The switching operation from the film roll screen to the index screen can be performed by reverse processing of the above processing. By performing the reverse processing of the above processing, it is also possible to lighten the load of the rotational processing.

### 1-7. Modified Example of Representative Image

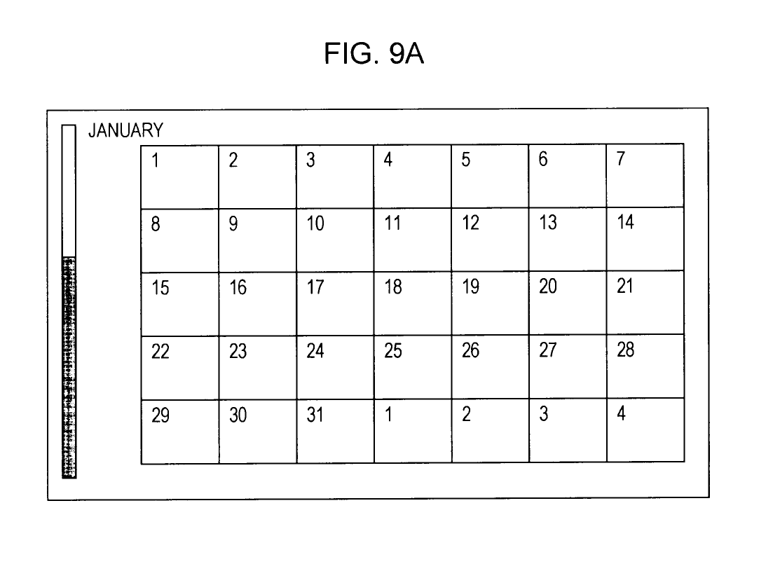

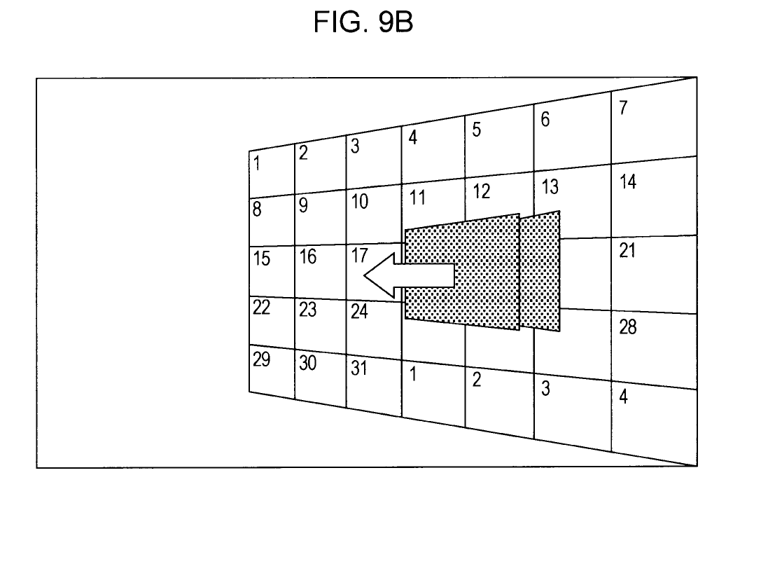

In the embodiment of the present invention, the representative image is not limited to a first frame of moving image data. FIG. 9A is an illustration showing another example of the index screen. For example, when managing still image data or moving image data by date, for example, in a calendar screen as shown in FIG. 9A, an image that is captured earliest on a date among still images and moving images captured on the date may be displayed for each date of the calendar. When a date is selected from the calendar screen shown in FIG. 9A, by using it as a trigger, it is possible to display a screen in which still image data or moving image data captured on the date is arranged as film roll images as a film roll screen.

FIG. 9B is an illustration showing a display example of the film roll screen formed by selecting a date on the calendar screen shown in FIG. 9A. Although detailed description of the switching operation from the calendar screen shown in FIG. 9A to the film roll screen shown in FIG. 9B will be omitted, in the same way as described above, the on-screen display circuit 116 rotationally draws the calendar screen and arranges the film roll images, so that the film roll screen shown in FIG. 9B can be displayed on the LCD panel 120.

### 1-8. Modified Example of Index Screen and Film Roll Screen

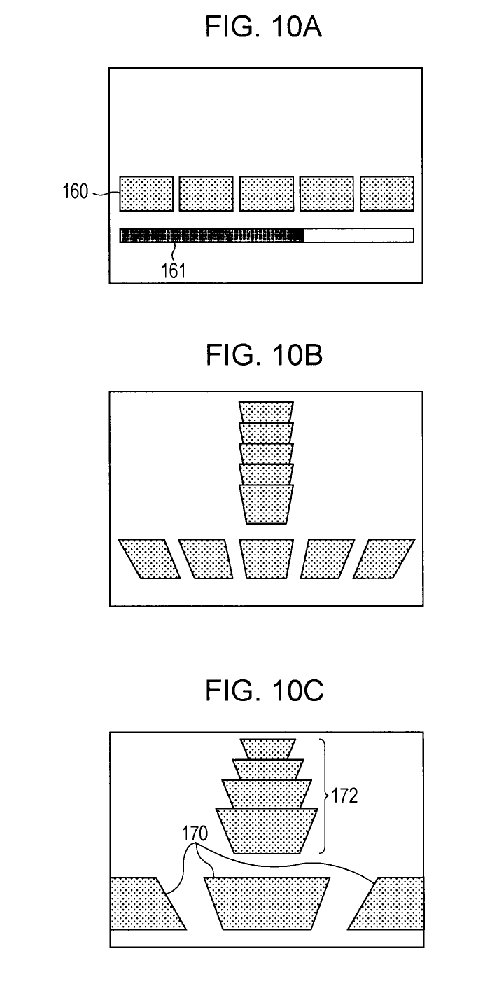

In the embodiment of the present invention, it is needless to say that the method for displaying the index screen and the film roll screen is not limited to the method described above. FIGS. 10A to 10C are illustrations showing another display example of the index screen and the film roll screen and another switching example from the index screen to the film roll screen.

FIG. 10A is an illustration showing another display example of the index screen. On the index screen shown in FIG. 10A, a plurality of representative images 160 and a scroll bar 161 are drawn. In this example, the plurality of representative images 160 are displayed in one horizontal row in the screen, and a user can change the representative images displayed on the screen by touching and selecting the area where the plurality of representative images 160 are displayed by using a finger or the like and moving the images to left or right.

In this situation, when the microprocessor 106 detects that any one of the representative images is selected, the microprocessor 106 instructs the on-screen display circuit 116 to switch the screen from the index screen to the film roll screen. FIG. 10B is an illustration showing a halfway state of the switching operation from the index screen shown in FIG. 10A to the film roll screen. As shown in FIG. 10B, the on-screen display circuit 116 that receives an instruction from the microprocessor 106 performs drawing processing in which the selected representative image is placed at the center and a plurality of representative images are tilted backward of the screen to be displayed three-dimensionally.

The on-screen display circuit 116 draws the film roll images generated from moving image data corresponding to the selected representative image by the recording/reproducing signal processing circuit 110 on an axis (in the vertical direction of the screen) perpendicular to the plane on which the plurality of representative images are displayed, and also performs drawing processing in which the film roll images are tilted backward of the screen to be displayed three-dimensionally. The film roll images shown in FIG. 10B are displayed so that the oldest image is displayed at the most front of the screen, and the more backward the image is located, the newer the image is.

As shown in FIG. 10C, finally, the on-screen display circuit 116 draws a plurality of film roll images 172 on an axis perpendicular to a plane on which a plurality of representative images that are enlarged and tilted backward, and displays the film roll images 172 on the LCD panel 120. By drawing the switching operation from the index screen to the film roll screen as described above, the correspondence relationship between the index screen and the film roll screen can be easily understood.

On the film roll screen shown in FIG. 10C, by scrolling up or down the area where a plurality of film roll images 172 are displayed, it is possible to sequentially change the displayed film roll images 172. When the microprocessor 106 detects an operation with a user's finger or the like, the microprocessor sends a control signal to change the displayed film roll screen 172 to the on-screen display circuit 116. When the on-screen display circuit 116 changes the display of the film roll screen 172, the on-screen display circuit 116 may sequentially hide old images.

The switching operation from the film roll screen to the index screen can be performed by reverse processing of the above processing.

In the above description, another example of the method for displaying the index screen and the film roll screen has been described. In the embodiment of the present invention, it is needless to say that the method for displaying the index screen and the film roll screen is not limited to the method described above if the method is to display the film roll images on an axis perpendicular to a plane on which a plurality of representative images are displayed.

The above described series of processing can be performed by hardware or software. When the series of processing is performed by software, a program constituting the software is installed from a program recording medium to a computer incorporated in dedicated hardware or a general-purpose personal computer or the like capable of executing various functions by being installed with various programs.

Although, in the above description, the digital video camera 100 is described as an example of the information processing device according to the embodiment of the present invention, it is needless to say that the present invention is not limited to this. It is needless to say that the above described processing can be performed by, for example, a video recording/reproducing device that is connected to a display device such as a TV set and used, a stationary type or a portable type game machine, a portable type content reproducing device that reproduces music and moving image, a mobile phone, and software installed in a personal computer.

### 2. OVERVIEW

As described above, according to the embodiment of the present invention, the film roll images generated from moving image data corresponding to the representative image selected from the plurality of representative images are displayed on the axis perpendicular to the plane on which the plurality of representative images are displayed, so that it is easy to understand the correspondence relationship between the index screen and the film roll screen. The screen is switched from the index screen to the film roll screen by animation, so that the operation of the index screen and the operation of the film roll screen are separated from each other, and it is easy to understand the correspondence relationship between the representative image selected by a user and the film roll images.

According to the embodiment of the present invention, when switching from the film roll screen to the index screen, the drawing processing in which the film roll images are moved back in the chronological direction and folded up is performed, and the folded-up film roll images are inserted in the blank position in the index screen, so that it is easy to know the position where the moving image data displayed as the film roll images was displayed in the index screen.

Although, the preferred embodiment of the present invention have been described in detail with reference to the accompanying drawings, the present invention is not limited the embodiment. It is obvious that a person with an ordinary skill in the art to which the present invention pertains can make various changes or modifications of the embodiment within the technical idea described in the claims of the present invention, and of course, it is understood that these changes or modifications are within the technical scope of the present invention.

For example, although in the above embodiment, on the film roll screen shown in FIG. 3C, the nearer the film roll image is located to the left edge of the screen, in other words, the older the film roll image is, the steeper the film roll image is tilted and displayed, the present invention is not limited to this example. For example, the on-screen display circuit 116 may draw all the film roll images so that the film roll images are tilted at the same angle, and may draw the film roll images having a rectangular shape instead of a trapezoidal shape.

For example, although in the above embodiment, a case in which the index screen and the film roll screen are displayed on the landscape LCD panel 120 is described, the present invention is not limited to this example. For example, the index screen and the film roll screen may be displayed on a portrait screen. When displaying the film roll screen on a portrait screen, the film roll images are displayed so that the upper the film roll image is located in the screen, the older the film roll image is.

For example, a sensor for detecting vertical and horizontal orientations is provided in the digital video camera 100, and the method for displaying the index screen and the film roll screen on the LCD panel 120 may be changed depending on the orientation of the digital video camera 100. Specifically, when the orientation of the digital video camera 100 is an orientation in which the LCD panel 120 is landscape mode, the index screen and the film roll screen are displayed on the LCD panel 120 as shown in FIGS. 2 and 3, and when the orientation of the digital video camera 100 is an orientation in which the LCD panel 120 is portrait mode, the film roll screen on which the older the film roll image is, the upper the film roll image is located may be displayed.

The present application contains subject matter related to that disclosed in Japanese Priority Patent Application JP 2009-250803 filed in the Japan Patent Office on Oct. 30, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing device comprising:
an image generator that generates a first image representing a content and one or more second images from the content including the first image, and
a display controller that displays the one or more first images on a first plane in a depth direction as seen from an image display screen, aligns one or more second images on an axis three-dimensionally perpendicular to the first plane on which the first images are displayed, and displays the images as a first screen.

2. The information processing device according to claim 1, wherein the display controller switches the screen from a second screen in which the first images are arranged on a second plane different from the first plane displayed in the first screen in the image display screen to the first screen by animation.

3. The information processing device according to claim 2, wherein, when the display controller switches the screen from the second screen to the first screen, the display controller switches a display plane of the first images from the second plane to the first plane by animation, and when the switching of the first images is completed, the display controller aligns and displays the second images on the axis three-dimensionally perpendicular to the first plane.

4. The information processing device according to claim 3, wherein the display controller displays the second images as if the second images popped up from the first plane by animation.

5. The information processing device according to claim 2, wherein, when the display controller switches the screen from the second screen to the first screen, the display controller switches the display plane of the first images from the second plane to the first plane by animation after framing out a part of the first images from the image display screen.

6. The information processing device according to claim 1, wherein the display controller switches the screen from the first screen to the second screen in which the first images are arranged on the second plane different from the first plane displayed in the first screen in the image display screen by animation.

7. The information processing device according to claim 6, wherein, when the display controller switches the screen from the first screen to the second screen, the display controller switches the display plane of the first images from the first plane to the second plane by animation after erasing the display of the second images.

8. The information processing device according to claim 7, wherein the display controller displays the second images as if the second images were moving to the first plane by animation.

9. The information processing device according to claim 6, wherein, when the display controller switches the screen from the first screen to the second screen, the display controller switches the display plane of the first images from the first plane to the second plane by animation after framing out a part of the first images from the image display screen.

10. The information processing device according to claim 1, wherein the second images show the content including the first image at a predetermined chronological interval, and chronologically newer second image is located nearer to the first plane on the axis three-dimensionally perpendicular to the first plane.

11. The information processing device according to claim 1, wherein the display controller displays the second images so that the second image is tilted steeper as the distance between the second image and the first plane increases.

12. The information processing device according to claim 1, wherein the display controller displays the second images so that all the second images are tilted at the same angle on the axis three-dimensionally perpendicular to the first plane.

13. The information processing device according to claim 1, wherein the display controller scrolls the second images on the axis three-dimensionally perpendicular to the first plane in accordance with a user operation.

14. The information processing device according to claim 1, wherein the display controller displays shades of the second images in accordance with the display of the second images.

15. The information processing device according to claim 1, wherein the display controller displays the second images by adding an effect for floating the second images from an area around the second images.

16. The information processing device according to claim 1, wherein the first image is an image of a first frame of the content.

17. The information processing device according to claim 1, wherein the display controller displays a calendar on the first plane, and the first image is an image captured for the first time on a date among images captured on the date.

18. The information processing device according to claim 1, wherein the display controller semi-transparently displays the first images displayed on the first plane.

19. An image display method comprising the steps of:
generating a first image representing a content and one or more second images from the content including the first image; and
displaying the one or more first images on a first plane in a depth direction as seen from an image display screen, aligning one or more second images on an axis three-dimensionally perpendicular to the first plane on which the first images are displayed, and displaying the images as a first screen.

20. An image display method for causing a computer to execute the steps of:
generating a first image representing a content and one or more second images from the content including the first image; and
displaying the one or more first images on a first plane in a depth direction as seen from an image display screen, aligning one or more second images on an axis three-dimensionally perpendicular to the first plane on which the first images are displayed, and displaying the images as a first screen.
